(19) United States
(12) Patent Application Publication
(10) Pub. No.: US 2009/0055478 A1
(43) Pub. Date: Feb. 26, 2009

(54) Communication terminal and communication program thereof

(75) Inventor: Shinji Hara, Fuchu-shi (JP)

Correspondence Address: COHEN, PONTANI, LIEBERMAN & PAVANE LLP, 551 FIFTH AVENUE, SUITE 1210, NEW YORK, NY, 10176, US

(73) Assignee: Casio Hitachi Mobile Communications Co., Ltd., Tokyo (JP)

(21) Appl. No.: 12/217,728

(22) Filed: Jul. 8, 2008

(30) Foreign Application Priority Data
Aug. 23, 2007 (JP) 2007-216897

(51) Int. Cl. G06F 15/16

(52) U.S. Cl. 709/204

(57) ABSTRACT

In communication terminals 1-1, 1-2, whenever data is received by any one of a mobile communication section 10-1, a wireless LAN communication section 10-2, or an infrared communication section 10-3, the received data type, communication method, time of receipt, communication partner, attachment data type and the time within the received data are detected as the reception result. Next, a central control section 10-10 identifies transmit data from the reception results based on an identification condition stored in an identification condition storage section 10-9-5. Subsequently, the identified transmit data is transmitted to the communication partner who originally transmitted the received data by the communication method used for receiving the transmit data identified.

### CROSS-REFERENCE TO RELATED APPLICATION

This application is based upon and claims the benefit of priority from the prior Japanese Patent Application No. 2007-216897, filed Aug. 23, 2007, the entire contents of which is incorporated herein by reference.

### BACKGROUND OF THE INVENTION

1. Field of the Invention

The present invention relates to a communication terminal and a communication program thereof.

2. Description of the Related Art

Conventionally, in a communication terminal such as a cellular phone, a variety of data such as profile data, schedule data, image data, and music data are transmitted and received by a variety of communication means such as mobile communication, infrared communication, wireless LAN communication, and cable communication. As one example thereof, a business card exchange function of transmitting and receiving mutual profile data with near field communication such as infrared communication has been put to practical use.

In the information exchange as described above, an art is known which simplifies a series of operations for reducing a burden of a user by moving to a certain operation, for example, a transmission operation after receiving data. For example, as business card exchange between mobile terminals, an art is disclosed in which when data is received in the state of waiting for receiving business card data from another terminal, a terminal ID and business card data received are registered, and the user's terminal ID and the user's business card data are transmitted to another terminal (for example, see Japanese Laid-Open (Kokai) Patent Publication No. 08-329017).

However, the above-described conventional prior art (Japanese Laid-Open (Kokai) Patent Publication No. 08-329017) has the following drawbacks.

One of the drawbacks is that because the data to be transmitted and received by a mobile terminal is limited to business card data, other data cannot be transmitted or received.

Another drawback is that when the user transmits another data, the user has to select desired data to be transmitted by the user operation, which makes the operation complicated.

### SUMMARY OF THE INVENTION

The object of the present invention is to provide a communication terminal and a communication program thereof that easily transmit appropriate transmit data to an appropriate communication partner in accordance with reception results when receiving data transmitted from a communication partner.

To accomplish the foregoing object, according to an aspect of the present invention, there is provided a communication terminal comprising: a reception means for receiving data transmitted from a communication partner; a detection means for detecting a reception result generated by the reception means; an identification means for identifying transmit data from among data previously stored based on the reception result detected by the detection means; and a transmission means for transmitting the transmit data identified by the identification means to the communication partner received by the reception means.

In accordance with another aspect of the present invention, there is provided a computer-readable storage medium having a communication program of a communication terminal stored thereon that is executable by a computer, comprising: reception processing for receiving data transmitted from a communication partner; detection processing for detecting a reception result generated by the reception processing; identification processing for identifying transmit data from among data previously stored based on the reception result detected by the detection processing; and transmission processing for transmitting the transmit data identified by the identification processing to the communication partner received by the reception means.

The present invention provides an advantage that the user can easily transmit appropriate transmit data to an appropriate communication partner in accordance with reception results when receiving data transmitted from a communication partner.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a block diagram showing a structure of communication terminals according to an embodiment of the present invention;

FIG. 2 is a block diagram showing a structure of the communication terminals 1-1, 1-2 according to the present embodiment;

FIG. 3 is a conceptual diagram showing example data stored in a profile storage section 10-9-1;

FIG. 4 is a conceptual diagram showing example data stored in a schedule storage section 10-9-2;

FIG. 5 is a conceptual diagram showing example data stored in an image storage section 10-9-3;

FIG. 6 is a conceptual diagram showing example data stored in a reception result storage section 10-9-4;

FIG. 7 is a conceptual diagram showing example data stored in an identification condition storage section 10-9-5;

FIG. 8 is a flowchart for explaining an operation (of a main routine) of the communication terminal 1 according to the present embodiment;

FIG. 9 is a flowchart for explaining an operation of data reception processing (Step S32);

FIG. 10 is a schematic drawing showing one example of a received data storage confirmation screen;

FIG. 11 is a flowchart for explaining an operation of reception result detection processing (Step S52);

FIG. 12 is a flowchart for explaining an operation of the transmit data identification processing (Step S62);

FIG. 13 is a flowchart for explaining an operation of the transmit data identification processing (Step S62);

FIG. 14 is a flowchart for explaining an operation of the transmit data identification processing (Step S62);

FIG. 15 is a flowchart for explaining an operation of transmission data processing (Step S64 in FIG. 9); and

FIG. 16 is a schematic drawing showing one example of a transmission data confirmation screen.

### DETAILED DESCRIPTION OF THE PREFERRED EMBODIMENTS

The present invention will hereinafter be described in detail with reference to the preferred embodiments shown in the accompanying drawings.

### A. Structure of the Embodiment

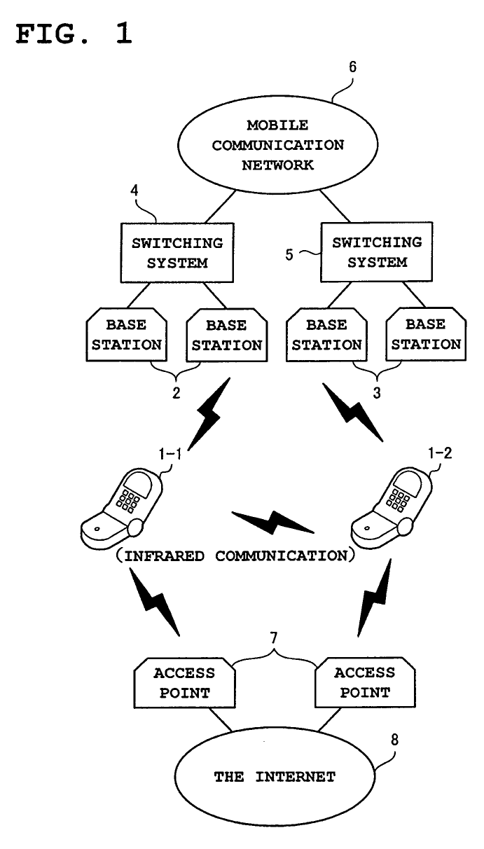

FIG. 1 is a block diagram showing a structure of a communication terminal according to an embodiment of the present invention.

In FIG. 1, communication terminals 1-1, 1-2 include, for example, a cellular phone or the like, and are connected via base stations 2, 3 and switching systems 4, 5 to a mobile communication network 6, whereby the communication terminals 1-1, 1-2 are capable of communicating with each other. In addition, the communication terminals 1-1, 1-2 are connected via an access point 7 to the Internet 8, whereby the communication terminals 1-1, 1-2 are capable of communicating with each other and viewing information provided on the Internet 8, for example, the Web page. Furthermore, the communication terminals 1-1, 1-2 are capable of transmitting and receiving data by infrared communication in a short distance. Although not shown, the mobile communication network 6 and the Internet 8 are connected such that the intercommunication therebetween is enabled.

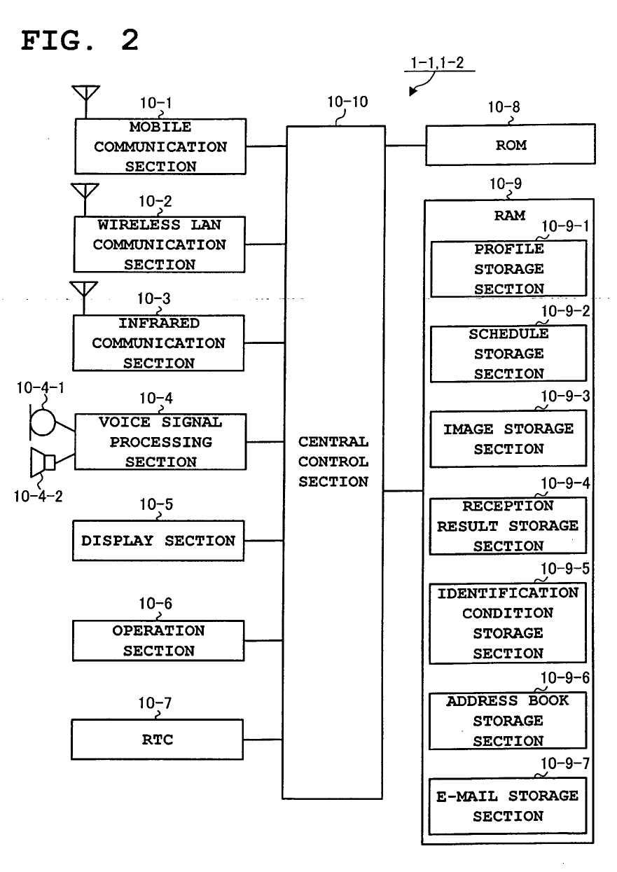

FIG. 2 is a block diagram showing a structure of the communication terminals 1-1, 1-2 according to the present embodiment. Hereinafter, the communication terminals 1-1, 1-2 will be referred to collectively as a communication terminal 1.

In FIG. 2, the communication terminal 1 includes a mobile communication section 10-1, a wireless LAN communication section 10-2, an infrared communication section 10-3, a voice signal processing section 10-4, a display section 10-5, an operation section 10-6, a real time clock (RTC) 10-7, a read only memory (ROM) 10-8, a random access memory (RAM) 10-9, and a central control section 10-10.

The mobile communication section 10-1, which is connected to the mobile communication network 6 via the base stations 2, 3 as shown in FIG. 1, performs voice communication, transmission and reception of a variety of data or the like with other communication terminals. The wireless LAN communication section 10-2, which is connected to the Internet 8 via the access point 7 shown in FIG. 1, transmits and receives information. The infrared communication section 10-3 transmits and receives data between communication terminals by infrared communication. The mobile communication section 10-1, the wireless LAN communication section 10-2 and the infrared communication section 10-3 as described above actualize functions of reception means.

The voice signal processing section 10-4 receives a voice from a microphone 10-4-1, converts the voice to a digital signal, and feeds the digital signal to the central control section 10-10, while converting a voice signal to an analog signal and outputting the analog signal from a speaker 10-4-2.

The display section 10-5 (display means), which includes a liquid crystal display instrument or the like, displays a variety of messages, images and the like. The operation section 10-6 (instruction means, communication partner change instruction means, and transmission change instruction means) inputs telephone numbers, a variety of data, operation instructions and the like. The RTC 10-7 clocks real time. The ROM 1-8 stores predetermined programs and a variety of parameters and the like.

The RAM 10-9 stores a variety of data. Particularly, the RAM 10-9 of the present embodiment includes a profile storage section 10-9-1, a schedule storage section 10-9-2, an image storage section 10-9-3, a reception result storage section 10-9-4, an identification condition storage section 10-9-5, an address book storage section 10-9-6, and an e-mail storage section 10-9-7. The profile storage section 10-9-1 stores private information of a user who uses the communication terminal 1. The schedule storage section 10-9-2 stores schedules on what and when to do.

The image storage section 10-9-3 stores image data and a list of information related to the image data. The reception result storage section 10-9-4 stores information related to reception results when receiving data from a communication partner. The identification condition storage section 10-9-5 stores a corresponding table for identifying transmit data among data previously stored based on reception results (that is, a received data type, communication means used in reception, a communication partner, a time of receipt, and information contained in received data). The address book storage section 10-9-6 stores names, telephone numbers, e-mail addresses and the like of communication partners. The e-mail storage section 10-9-7 stores e-mails transmitted and received.

The central control section 10-10 executes the programs stored in the ROM 10-8, and controls operations in various sections. Particularly, the central control section 10-10 of the present embodiment detects reception results of received data (that is, the received data type, the communication means used in reception, the communication partner, the time of receipt, and the information contained in the received data), identify transmit data among data previously stored in the identification condition storage section 10-9-5 based on the reception results, and display a confirmation screen for confirming whether or not to transmit the identified transmit data on the display section 10-5. When transmission of the transmit data is instructed by user operation, the central control section 10-10 transmits the identified transmit data to the communication partner.

The central control section 10-10 herein actualizes functions of detection means, identification means and transmission means.

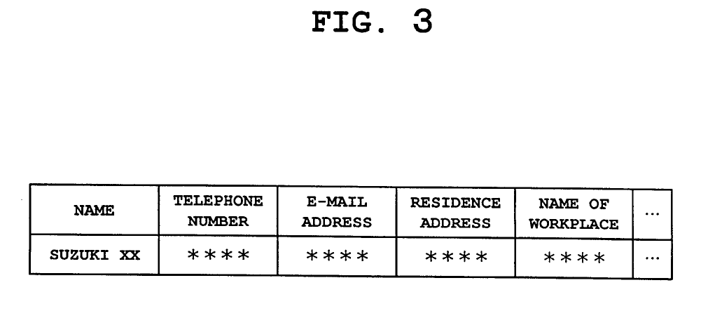

FIG. 3 is a conceptual diagram showing example data stored in the profile storage section 10-9-1. In the diagram, a name, a telephone number, an e-mail address, a residence address, a name of workplace and the like are stored in the profile storage section 10-9-1 as private information of a user who uses the communication terminal 1.

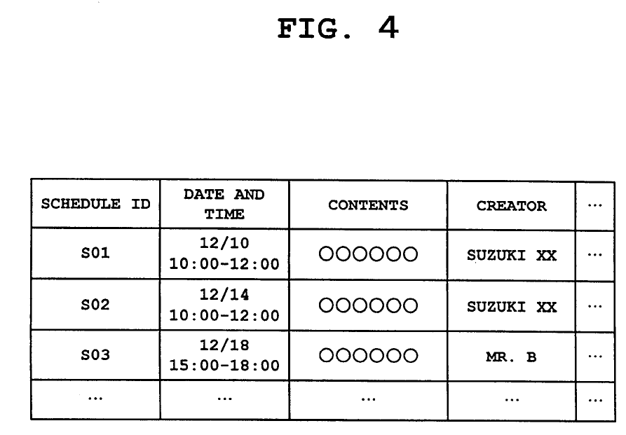

FIG. 4 is a conceptual diagram showing example data stored in the schedule storage section 10-9-2. In the diagram, information including a date and time, contents, a creator and the like for each schedule ID is stored in the schedule storage section 10-9-2. When it is registered by a user of the communication terminal 1, the user's own name is assigned to “creator”, and when it is received from a communication partner and stored, the name of the partner is assigned to “creator”.

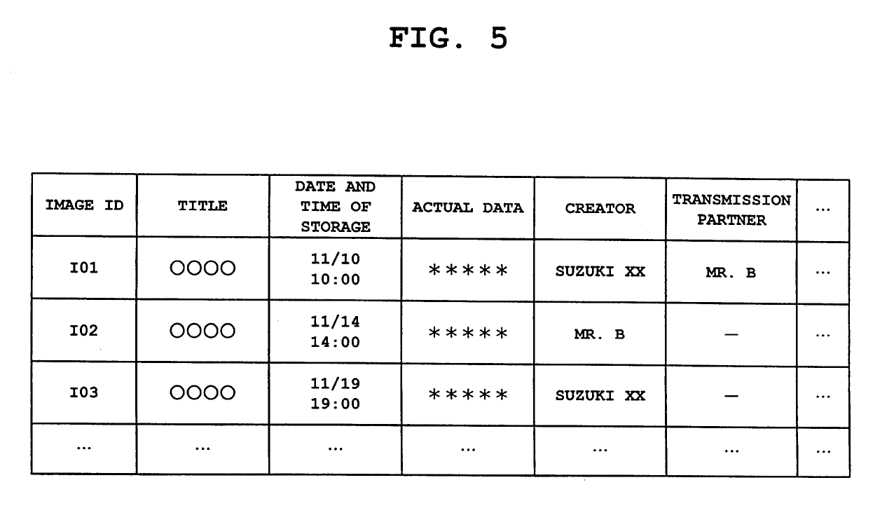

FIG. 5 is a conceptual diagram showing example data stored in the image storage section 10-9-3. In the diagram, the image storage section 10-9-3 consists of a title, a date and time of storage (that is, a date and time when data was stored, which may be alternatively a date and time when the data was photographed or downloaded), actual data (that is, image data itself, which may be either a still image or a movie), a creator, a transmission partner and the like, of image data. As is the case with the schedule, when it is created by a user of the communication terminal 1, the user's own name is assigned to “creator”, and when it is data received from a communication partner and stored, the name of the partner is assigned to “creator”. Also, “transmission partner” is information for specifying a partner when transmitting to another communication partner (that is, the name of the partner). When the partner is a specific single person, a flag for indicating that transmission is made to the communication partner may be alternatively used.

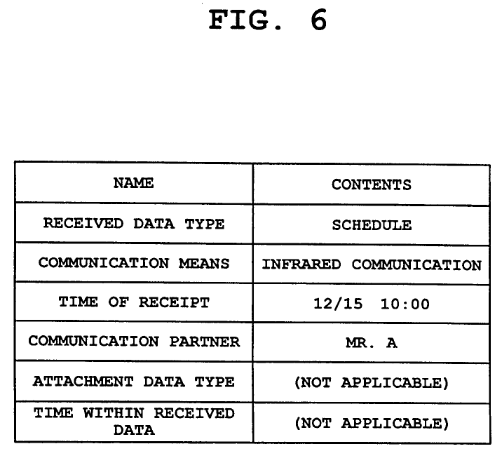

FIG. 6 is a conceptual diagram showing example data stored in the reception result storage section 10-9-4. In the diagram, a received data type (such as profile, schedule, e-mail and image data), communication means (such as wireless LAN communication and infrared communication), a time of receipt, a communication partner, an attachment data type (in the case where received data has attachment data) and a time within received data, of data received from a communication partner are stored in the reception result storage section 10-9-4.

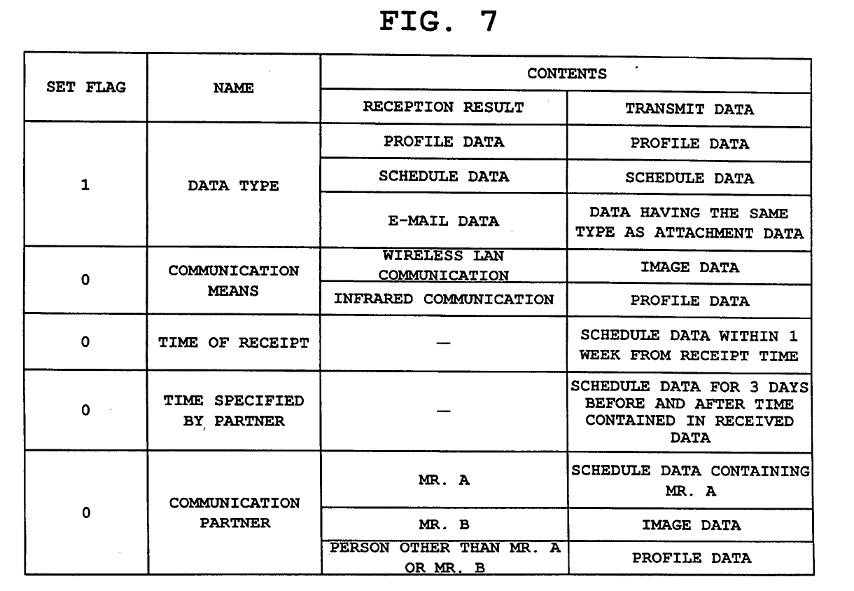

FIG. 7 is a conceptual diagram showing an example of data stored in the identification condition storage section 10-9-5 which consists of a set flag, a name and contents. The set flag is in either of the states “0” or “1”. The flag is set to “0” when the identification condition is not used in identifying transmit data, and is set to “1” when the identification condition is used in identifying transmit data. The names of the identification conditions include a data type, communication means, a time of receipt, a time specified by a partner and a communication partner. The data type refers to a transmit data type corresponding to a received data type. In the illustrated example, setting has been made as follows: in the case where profile data is received, profile data is transmitted; in the case where schedule data is received, schedule data is transmitted; and in the case where e-mail data is received, data of the same type as that of attachment data of the e-mail is transmitted.

The communication means refers to a transmit data type corresponding to communication means used when data is received. In the illustrated example, setting has been made as follows: in the case where data is received by wireless LAN communication, image data is transmitted; and in the case where data is received by infrared communication, profile data is transmitted. Furthermore, the time of receipt refers to transmit data corresponding to a time at which received data is received. In the illustrated example, setting has been made such that schedule data within one week from a time of receipt is transmitted.

The time specified by partner refers to transmit data corresponding to time information contained in received data (such as a time contained in schedule data and a time contained in a text of an e-mail). In the illustrated example, setting has been made such that schedule data for three days before and after a time contained in received data is transmitted. The communication partner refers to a transmit data corresponding to a communication partner of received data. In the illustrated example, setting has been made as follows: in the case where data is received from Mr. A, schedule data containing Mr. A is transmitted; in the case where data is received from Mr. B, image data is transmitted, and in the case where data is received from a person other than Mr. A or Mr. B, profile data is transmitted.

### B. Operation of the Embodiment

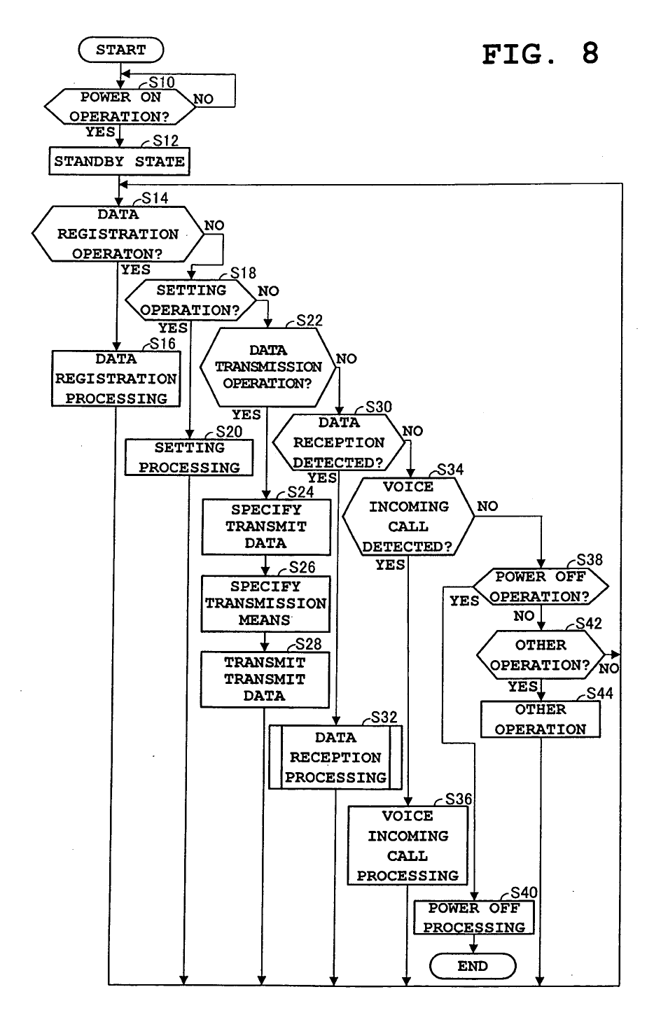

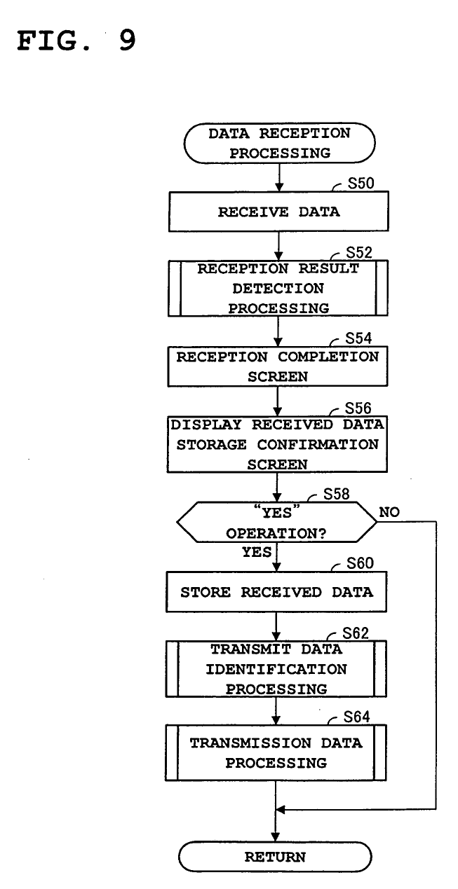

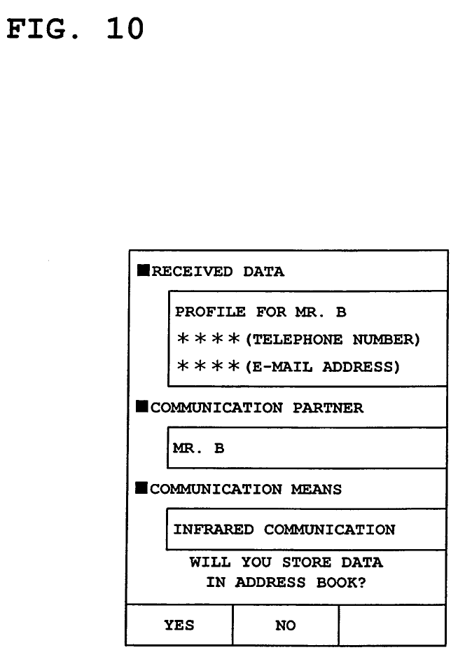

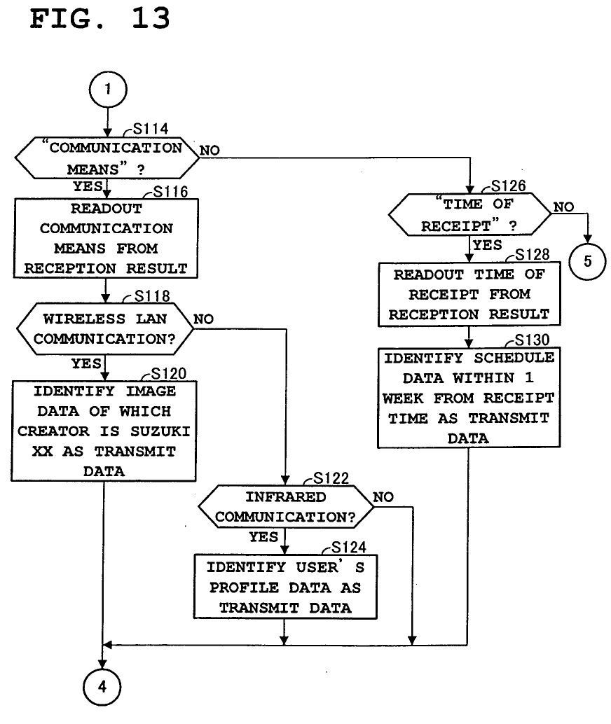

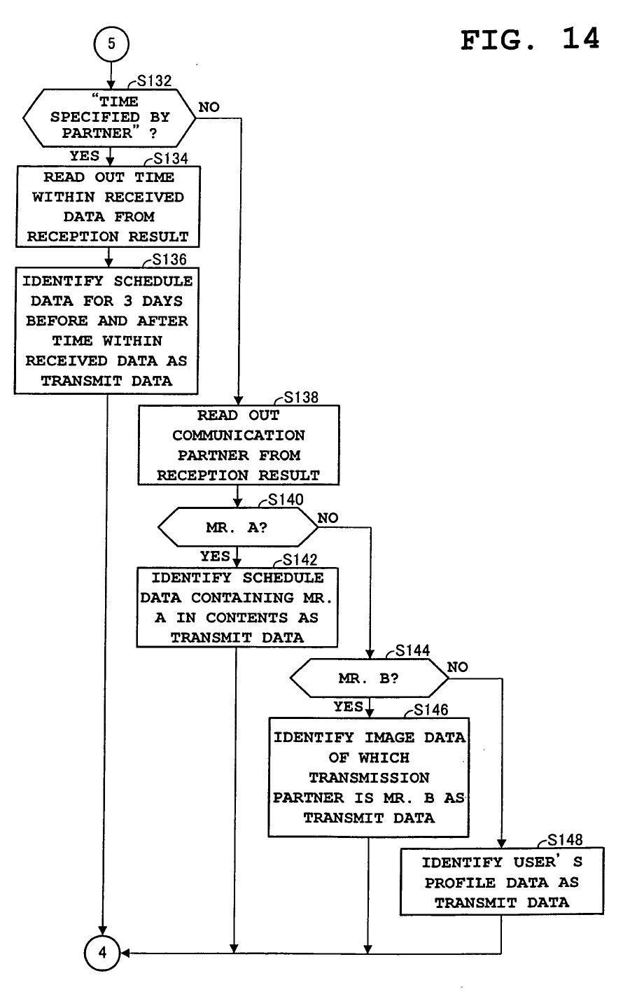

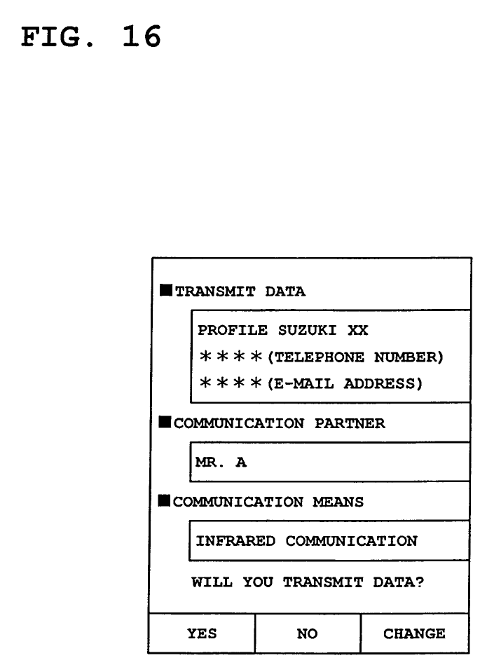

An operation of the above-described embodiment will hereinafter be explained. Herein, FIG. 8, FIG. 9 and FIG. 11 to FIG. 15 are flowcharts for explaining an operation of the communication terminal 1. Meanwhile, FIG. 10 and FIG. 16 are schematic drawings showing a display example of the communication terminal 1.

FIG. 8 is a flowchart for explaining an operation (the main routine) of the communication terminal 1 according to the present embodiment. First, the central control section 10-10 judges whether or not a power ON operation has been performed (Step S10). When judged that the power has been turned ON, the central control section 10-10 controls the display section 10-5 to display a standby screen and turns the state into a standby state for standing by for a variety of operations, incoming calls or the like (Step S12). Next, the central control section 10-10 judges whether or not a data registration operation has been performed in the standby state (Step S14). When judged that the data registration operation has been performed, the central control section 10-10 executes data registration processing (Step S16). In the data registration processing, registrations of profile, schedule, and address book, image shootings, downloaded data or the like are performed.

On the contrary, when judged that the registration operation has not been performed in the standby state, the central control section 10-10 judges whether or not a setting operation has been performed (Step S18). When judged that the setting operation has been performed, the central control section 10-10 executes setting processing of identification condition in the identification condition storage section 10-9-5 as shown in FIG. 7 (Step S20).

In the case where a data transmission operation has been performed by mobile communication, wireless LAN communication, or infrared communication in the standby state (YES at Step S22), the central control section 10-10 requests the user to specify transmit data (Step S24), further requests the user to specify transmission means (Step S26), and transmits the above-described specified transmit data by the specified transmission means (Step S28).

In the case where the central control section 10-10 has detected a data reception performed by mobile communication, wireless LAN communication, or infrared communication in the standby state (YES at Step S30), the central control section 10-10 executes data reception processing (Step S32).

In the case where a voice incoming call has been detected in the standby state (Step S34, YES), the central control section 10-10 executes ordinary voice incoming call processing (Step S36). In the case where a power OFF operation has been performed in the standby state (Step S38, YES), the central control section 10-10 executes power OFF processing (Step S40). In the case where other operation such as a voice transmission operation has been performed in the standby state (YES at Step S42), the central control section 10-10 executes other processing corresponding to the operation (Step S44).

The next FIG. 9 is a flowchart for explaining an operation of the above-described data reception processing (Step S32). In the data reception processing, the reception means first receives data (Step S50). Then, the central control section 10-10 executes reception result detection processing (Step S52), and subsequently controls the display section 10-5 to display a reception completion screen (Step S54). Next, as shown in FIG. 10, the display section 10-5 displays a received data storage confirmation screen (Step S56). The content of the received data, the communication partner and the communication means are displayed on the received data storage confirmation screen. In addition, “YES” and “NO” buttons for the user to select whether or not to store the received data are displayed at the bottom of the screen. The user selects “YES” when the user desires the received data to be stored, and selects “NO” when the user does not desire the received data to be stored.

Subsequently, the central control section 10-10 judges whether or not an operation of selecting “YES” has been performed on the above-described received data storage confirmation screen (Step S58). When judged that the operation of selecting “YES” has been performed, the received data is stored (Step S60). In the case where the received data is profile data, the received data is stored in the address book storage section 10-9-6. In the case of schedule data, the received data is stored in the schedule storage section 10-9-2. In the case of image data, the received data is stored in the image storage section 10-9-3. In the case of e-mail, the received data is stored in the e-mail storage section 10-9-7. Next, the central control section 10-10 executes transmit data identification processing for identifying transmit data in accordance with the reception results (Step S62), and executes transmission data processing for transmitting the transmit data (Step S64).

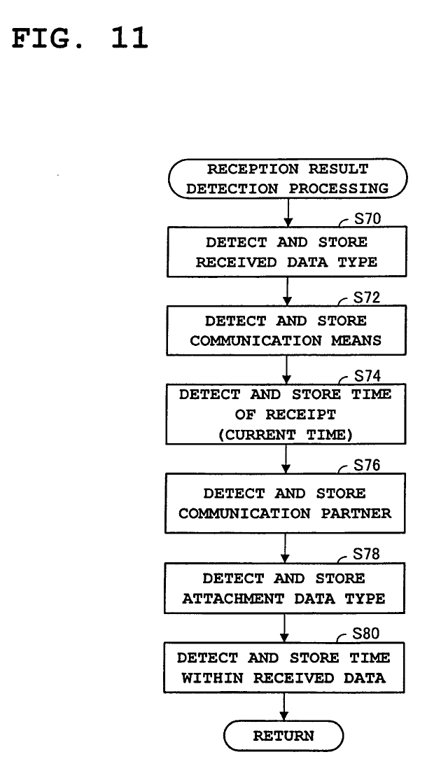

The next FIG. 11 is a flowchart for explaining an operation of the above-described reception result detection processing (Step S52). In the reception result detection processing, the central control section 10-10 first detects and stores the type (Step S70), the communication means (Step S72), and the time of receipt (that is, the current time clocked by the RTC 10-7) (Step S74) of the received data in this sequence. Next, it detects and stores the communication partner (Step S76). When there is attachment data in the case where the received data is an e-mail, the central control section 10-10 detects and stores the attachment data type (Step S78). Furthermore, when there is a time contained in the received data, that is, a time within the received data, the central control section 10-10 detects and stores the time (Step S80). Subsequently, the central control section 10-10 returns to the main routine.

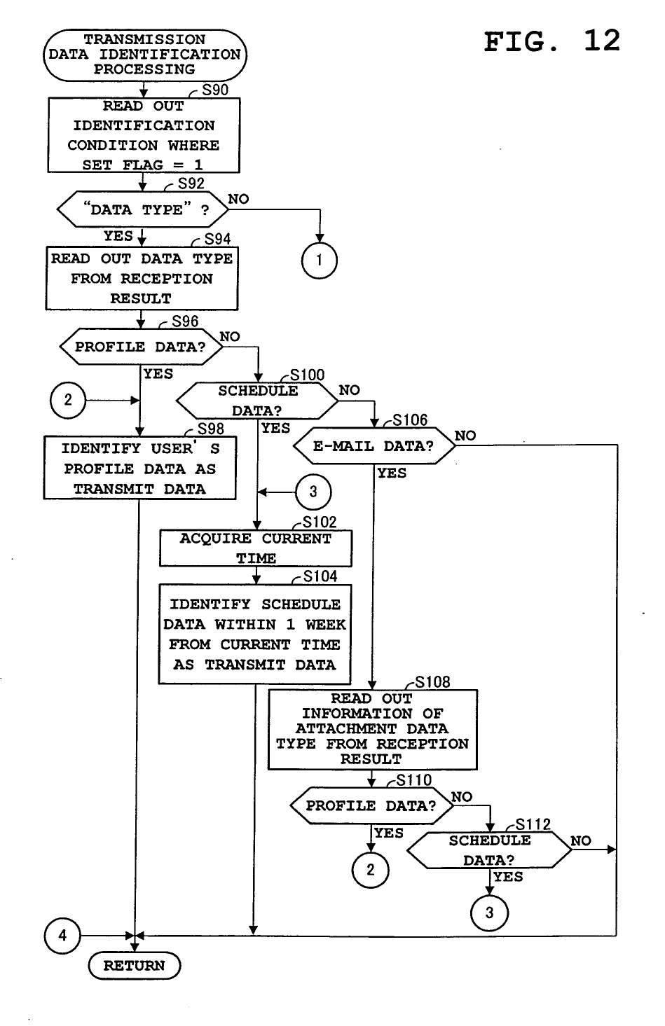

The next FIG. 12 to FIG. 14 are flowcharts for explaining an operation of the above-described transmit data identification processing (Step S62). In the transmit data identification processing, the central control section 10-10 first reads out the identification condition of which the set flag is “1” (Step S90), and judges whether or not the identification condition is “data type” (Step S92). Subsequently, when judged that the identification condition read out is “data type”, the central control section 10-10 reads out the data type from the reception results stored in the reception result storage section 10-9-4 (Step S94), and judges whether or not the data type is profile data (Step S96). Subsequently, when judged that the received data type is profile data, the central control section 10-10 identifies, as the transmit data, the user's profile data stored in the profile storage section 10-9-1 in accordance with the-contents in the identification condition storage section 10-9-5 (Step S98).

On the contrary, when the received data type is not profile data, the central control section 10-10 judges whether or not the data type is schedule data (Step S100). Subsequently, when judged that the received data type is schedule data, the central control section 10-10 acquires the current time from the RTC 10-7 (Step S102) and identifies, as the transmit data, schedule data within one week from the current time in accordance with the contents in the identification condition storage section 10-9-5 (Step S104).

When the received data type is not profile data or schedule data, the central control section 10-10 judges whether or not the data type is e-mail data (Step S106). Subsequently, when judged that the received data type is e-mail data, the central control section 10-10 reads out the type information of the attachment data from the reception results (Step S108), and judges whether or not the attachment data is profile data (Step S110). When judged that the attachment data is profile data, the central control section 10-10 advances to Step S98, where it identifies the user's profile data as the transmit data.

On the contrary, when the attachment data is not profile data, the central control section 10-10 judges whether or not the attachment data is schedule data (Step S112). When judged that the attachment data is schedule data, the central control section 10-10 advances to Step S102 where it acquires the current time. Next, at Step S104, the central control section 10-10 identifies schedule data within one week from the current time as the transmit data. Note that the schedule data to be identified is not limited to schedule data for a predetermined period of time. Instead, it may be schedule data previously specified by the user, or it may be all schedule data.

When the attachment data of the e-mail is neither profile data nor schedule data (NO at Step S112), or, when the received data type is none of profile data, schedule data, nor e-mail data (NO at Step S106), the central control section 10-10 ends the processing without executing any further processing, and returns to the data reception processing shown in FIG. 9.

When the identification condition of which the set flag is “1” is not “data type” at Step S92, the central control section 10-10 judges whether or not the identification condition is “communication means” (Step S114). Subsequently, when judged that the identification condition is “communication means”, the central control section 10-10 reads out “communication means” from the reception results stored in the reception result storage section 10-9-4 (Step S116), and judges whether or not “communication means” used in the data reception is wireless LAN communication (Step S118). Subsequently, when judged that “communication means” is wireless LAN communication, the central control section 10-10 identifies the image data of which the creator is Suzuki XX as the transmit data in accordance with the contents in the identification condition storage section 10-9-5 (Step S120). Then, the central control section 10-10 ends the processing and returns to the data reception processing shown in FIG. 9. Note that, at Step S120, the image data to be identified is not limited to image data created by the user. Instead, it may be image data previously specified by the user, or it may be all image data.

On the contrary, when judged that “communication means” used in the data reception is not wireless LAN communication, the central control section 10-10 judges whether or not the communication means is infrared communication (Step S122). When judged that “communication means” is infrared communication, the central control section 10-10 identifies the user's profile data stored in the profile storage section 10-9-1 as the transmit data in accordance with the contents in the identification condition storage section 10-9-5 (Step S124). In the case where “communication means” used in the data reception is neither of wireless LAN communication nor infrared communication, the central control section 10-10 ends the processing, and returns to the data reception processing shown in FIG. 9.

When the identification condition of which the set flag is “1” is not “communication means” at Step S114, the central control section 10-10 judges whether or not the identification condition is “time of receipt” (Step S126). Subsequently, when judged that the identification condition is “time of receipt”, the central control section 10-10 reads out “time of receipt” from the reception results stored in the reception result storage section 10-9-4 (Step S128). Subsequently, the central control section 10-10 identifies schedule data within one week from “time of receipt” of the received data as the transmit data in accordance with the contents in the identification condition storage section 10-9-5 (Step S130). Then, the central control section 10-10 ends the processing, and returns to the data reception processing shown in FIG. 9.

When the identification condition of which the set flag is “1” is not “time of receipt” at Step S126, the central control section 10-10 judges whether or not the identification condition is “time specified by partner” (Step S132). When judged that the identification condition is “time specified by partner”, the central control section 10-10 reads out “time within received data” from the reception results stored in the reception result storage section 10-9-4 (Step S134). Subsequently, it identifies, as the transmit data, schedule data for three days before and after the time within the received data, in accordance with the contents in the identification condition storage section 10-9-5, (Step S136), and returns to the data reception processing shown in FIG. 9 after ending the processing.

When the identification condition of which the set flag is “1” is not “time specified by partner” at Step S132, the identification condition is “communication partner” (see FIG. 7). Accordingly, the central control section 10-10 reads out “communication partner” from the reception results stored in the reception result storage section 10-9-4 (Step S138). Next, the central control section 10-10 judges whether or not “communication partner” is “Mr. A” (Step S140). When judged that “communication partner” is “Mr. A”, the central control section 10-10 identifies schedule data containing “Mr. A” in the contents as the transmit data, in accordance with the contents in the identification condition storage section 10-9-5 (Step S142), and returns to the data reception processing shown in FIG. 9 after ending the processing. Note that, at Step S142, the schedule data to be identified is not limited to schedule data containing the communication partner in the contents. Instead, the schedule data to be identified may be schedule data previously stored in the manner it corresponds to the communication partner.

On the contrary, when the “communication partner” is not “Mr. A”, the central control section 10-10 judges whether or not the communication partner is “Mr. B” (Step S144). When judged that “communication partner” is “Mr. B”, it identifies image data of which the transmission partner is Mr. B (see FIG. 5) as the transmit data in accordance with the contents in the identification condition storage section 10-9-5 (Step S146), and returns to the data reception processing shown in FIG. 9 after ending the processing.

In the case where the “communication partner” is neither “Mr. A” nor “Mr. B”, the central control section 10-10 identifies the user's profile data stored in the profile storage section 10-9-1 as the transmit data, in accordance with the contents in the identification condition storage section 10-9-5 (Step S148). Subsequently, the central control section 10-10 ends the processing and returns to the data reception processing shown in FIG. 9.

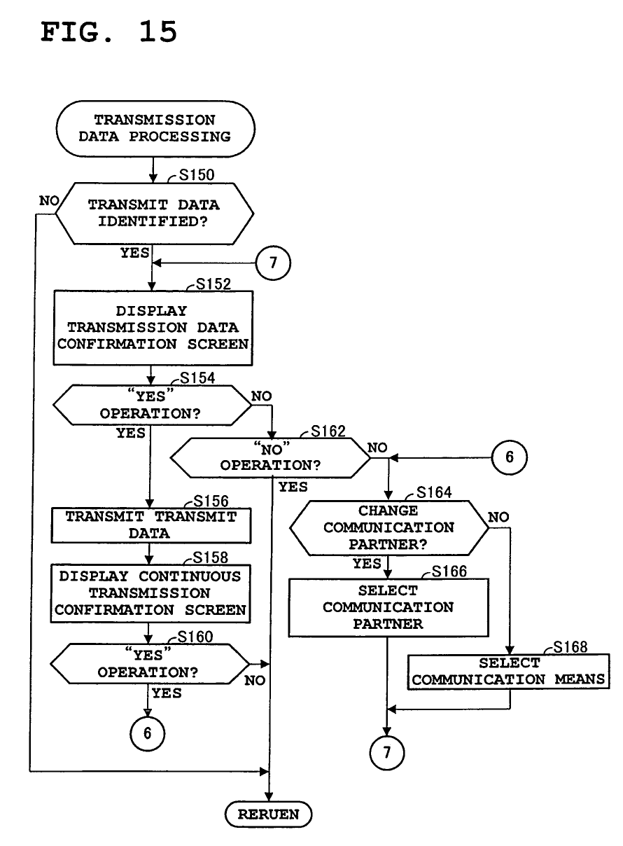

The next FIG. 15 is a flowchart for explaining an operation of the above-described transmission data processing (Step S64 in FIG. 9). In the transmission data processing, the central control section 10-10 first judges whether or not transmit data has been identified by the above-described transmit data identification processing (Step S150). Subsequently, when judged that transmit data has not been identified, the central control section 10-10 ends the processing without executing any further processing, and returns to the data reception processing shown in FIG. 9.

On the contrary, when judged that transmit data has been identified, the display section 10-5 displays a transmission data confirmation screen shown in FIG. 16 (Step S152). The contents of the transmit data, the communication partner and the communication means are displayed on the transmission data confirmation screen. In addition, “YES” and “NO” buttons used for the user to select whether or not to transmit the transmit data and a “CHANGE” button used for changing the communication partner or the communication means are displayed at the bottom of the screen. The user selects “YES” when the user desires the transmit data to be transmitted, and the user selects “NO” when the user does not desire the transmit data to be transmitted. The user selects “CHANGE” when the user desires the communication partner or the communication means to be changed.

Subsequently, the central control section 10-10 judges whether or not an operation of selecting “YES” has been performed on the above-described transmission data confirmation screen (Step S154). When judged that the operation of selecting “YES” has been performed, the central control section 10-10 transmits the identified transmit data (Step S156), and the display section 10-5 displays a continuous transmission confirmation screen (Step S158). On the continuous transmission confirmation screen, the user confirms whether or not to perform continuous transmission by changing the communication partner or by changing the communication means.

After judging whether or not the operation of selecting “YES” has been performed on the continuous transmission confirmation screen (Step S160), when judged that the operation of selecting “YES” has not been performed, in other words, when judged that an operation of selecting “NO” has been performed, the central control section 10-10 ends the processing without performing continuous transmission, and returns to the transmission data processing shown in FIG. 9. On the contrary, when judged that the operation of selecting “YES” has been performed on the continuous transmission confirmation screen, the central control section 10-10 advances to Step S164, which will be described later, so as to change the communication partner or the communication means.

When judged that the operation of selecting “YES” has not been performed on the transmission data confirmation screen (NO at Step S154), the central control section 10-10 judges whether or not the operation of selecting “NO” has been performed (Step S162). When judged that the operation of selecting “NO” has been performed, the central control section 10-10 ends the processing without transmitting the transmit data, and returns to the data reception processing shown in FIG. 9.

When neither of the operation of selecting “YES” nor the operation of selecting “NO” has been performed on the transmission data confirmation screen, in other words, when an operation of selecting “change” has been performed, or alternatively when the operation of selecting “YES” has been performed at the above-described Step S160, the central control section 10-10 judges whether or not the operation is to change the communication partner or to change the communication means (Step S164). When judged that the operation is to change the communication partner, the central control section 10-10 requests the user to select the communication partner (Step S166), and when judged that the operation is to change the communication means, it requests the user to select the communication means (Step S168). Subsequently, the central control section 10-10 returns to Step S152, where the display section 10-5 displays the transmission data confirmation screen. Thereafter the central control section 10-10 repeats the above-described operation.

According to the above-described embodiment, the central control section 10-10 identifies transmit data based on reception results when receiving data transmitted from a communication partner, and transmits the identified transmit data to the communication partner. Accordingly, the user can easily transmit appropriate transmit data in accordance with the reception results to the communication partner.

In addition, the display section 10-5 displays confirmation information for confirming whether or not to transmit identified transmit data before transmitting the transmit data. Accordingly, the user can easily confirm whether or not the identified transmit data is appropriate and whether or not to transmit the identified transmit data to the communication partner.

In addition, the central control section 10-10 identifies transmit data in accordance with a received data type. For example, the central control section 10-10 identifies, as the transmit data, data that has the same type as the received data, or data that has a type related to the received data. Accordingly, the user can easily transmit appropriate data in accordance with the received data type.

In addition, the central control section 10-10 identifies transmit data in accordance with communication means used for receiving data. For example, the central control section 10-10 identifies, as the transmit data, data having a size corresponding to the transmission capability of the communication means used for receiving the data, or it identifies private data as the transmit data in the case of direct communication between terminals. Accordingly, the user can easily transmit appropriate data in accordance with the communication means used for receiving the data.

In addition, the central control section 10-10 identifies transmit data in accordance with a time of receipt. For example, the central control section 10-10 identifies, as the transmit data, a schedule around the time of receipt, or data created around the time of receipt. Accordingly, the user can easily transmit appropriate data in accordance with the time of receipt.

In addition, the central control section 10-10 identifies transmit data in accordance with a communication partner. For example, the central control section 10-10 identifies, as the transmit data, private data when transmitting to a close acquaintance, or it identifies data having a type which is often exchanged with the communication partner as the transmit data. Accordingly, the user can easily transmit appropriate data in accordance with the communication partner.

In addition, the central control section 10-10 identifies transmit data in accordance with information contained in received data. For example, the central control section 10-10 identifies data that has the same type as the data attached to the e-mail as the transmit data, schedule data around a time contained in the received data, or data containing a person's name contained in the received data. Accordingly, the user can easily transmit appropriate data in accordance with the information contained in the received data.

In addition, the user can change a communication partner on the transmission data confirmation screen when transmitting data. As a result, the user can easily transmit the identified data also to a communication partner other than a communication partner from whom the user received data.

In addition, the user can change communication means on the transmission data confirmation screen when transmitting data. As a result, the user can easily transmit the identified data also by communication means other than communication means used for receiving data.

Note that in the above-described embodiment, the communication means is not limited to mobile communication, wireless LAN communication or infrared communication. The communication means may be radio communication of other type or may be cable communication. In addition, the data is not limited to profile data, schedule data or image data. In addition, the type of the data to be transmitted in accordance with a time of receipt or a time specified by a partner is not limited to schedule data. For example, data other than schedule data may also be identified, and the data may be identified in accordance with a time the data was stored or a time the data was shot (in the case of image data). In addition, the communication terminal is not limited to a cellular phone. For example, the embodiment may also be applicable to a laptop computer, a personal digital assistance (PDA), an electronic camera, an electronic wrist watch, a music player or the like having a communication function.

Furthermore, although the computer program product of the communication terminal which is a preferred embodiment of the present invention is stored in the memory (for example, ROM, etc.) of the communication terminal, this processing program is stored on a computer-readable medium and should also be protected in the case of manufacturing, selling, etc. of only the program. In that case, the method of protecting the program with a patent will be realized by the form of the computer-readable medium on which the computer program product is stored.

While the present invention has been described with reference to the preferred embodiments, it is intended that the invention be not limited by any of the details of the description therein but includes all the embodiments which fall within the scope of the appended claims.

What is claimed is:

1. A communication terminal comprising:
a reception means for receiving data transmitted from a communication partner;
a detection means for detecting a reception result generated by the reception means;
an identification means for identifying transmit data from among data previously stored based on the reception result detected by the detection means; and
a transmission means for transmitting the transmit data identified by the identification means to the communication partner received by the reception means.

2. The communication terminal according to claim 1, further comprising:
a display means for displaying confirmation information to confirm whether or not to transmit the transmit data identified by the identification means; and
an instruction means for directing transmission of the transmit data based on the confirmation information displayed by the display means;
wherein the transmission means, whenever transmission is directed by the instruction means, transmits the transmit data.

3. The communication terminal according to claim 1, wherein the detection means detects the received data type as the reception result; and
wherein the identification means identifies the transmit data based on the data type detected by the detection means.

4. The communication terminal according to claim 1, further comprising:
a plurality of reception means; and
wherein the detection means detects the reception means used for data reception from among the plurality of reception means as the reception result; and
wherein the identification means identifies the transmit data based on the reception means detected by the detection means from among the plurality of reception means.

5. The communication terminal according to claim 1, wherein the detection means detects time of receipt information of the received data as the reception result; and
wherein the identification means identifies the transmit data based on the time of receipt information of the received data detected by the detection means.

6. The communication terminal according to claim 1, wherein the detection means detects the communication partner of the received data as the reception result; and
wherein the identification means identifies the transmit data based on the communication partner detected by the detection means.

7. The communication terminal according to claim 1, wherein the detection means detects information contained in the received data as the reception result; and
wherein the identification means identifies the transmit data based on the information contained in the received data detected by the detection means.

8. The communication terminal according to claim 1, further comprising:
a communication partner change instruction means for directing a change of the communication partner to whom the transmit data is to be transmitted; and
wherein the transmission means, whenever a change instruction from the communication partner change instruction means occurs, transmits the transmit data identified by the identification means to the communication partner based on the change instruction.

9. The communication terminal according to claim 1, further comprises:
a plurality of transmission means; and
a transmission change instruction means for directing a change of the transmission means used to transmit the transmit data;
wherein, whenever a change instruction from the transmission change instruction means occurs, the transmit data identified by the identification means is transmitted by the transmission means based on the change instruction.

10. A computer-readable storage medium having a communication program of a communication terminal stored thereon that is executable by a computer, comprising:
reception processing for receiving data transmitted from a communication partner;
detection processing for detecting a reception result generated by the reception processing;
identification processing for identifying transmit data from among data previously stored based on the reception result detected by the detection processing; and
transmission processing for transmitting the transmit data identified by the identification processing to the communication partner received by the reception means.
